(19) United States
(12) Patent Application Publication
(10) Pub. No.: US 2019/0030524 A1
(43) Pub. Date: Jan. 31, 2019

(54) ISOLATOR, ISOLATOR SYSTEM AND METHOD

(71) Applicant: METALL + PLASTIC GMBH, Radolfzell (DE)

(72) Inventor: Stefan Kleinmann, Radolfzell (DE)

(73) Assignee: METALL + PLASTIC GMBH, Radolfzell (DE)

(21) Appl. No.: 16/072,206

(22) PCT Filed: Jan. 12, 2017
(86) PCT No.: PCT/EP2017/050523

§ 371 Date: Oct. 2, 2018

(30) Foreign Application Priority Data
Jan. 25, 2016 (DE) 10 2016 101 195.9

(51) Int. Cl. B01L 1/02

(52) U.S. Cl. CPC B01L 1/025; B01L 2200/0689; B01L 2300/0854; B01L 2200/025

(57) ABSTRACT

An isolator (1), for pharmaceutical and/or chemical applications, including an isolator space (5) having a double wall (2), wherein the double wall (2) comprises at least one transparent outer wall panel (8) and a transparent inner wall panel (7) at a distance to same, which delimit an intermediate space (9), for conducting gas, and including at least one glove port (3) associated with the double wall (2), comprising means for detachably fixing a glove (4) for extending through the double wall (2) to manually engage in the isolator space (5), wherein the glove port (4) has a channel ring (10) which surrounds a reach-through channel (13), is transparent, and which extends from the outer wall panel (8) in the direction of the inner wall panel (7). According to the invention, the means for the detachable fixing of the glove (4) is arranged in a region between the outer wall panel (8) and the inner wall panel (7) outside the reach-through channel (13).

### BACKGROUND OF THE INVENTION

The invention relates to an isolator (clean room device), in particular for pharmaceutical and/or chemical applications, with an isolator space having a double wall, wherein the double wall comprises at least one transparent outer wall panel preferably formed from glass or a transparent plastic and, spaced apart from the latter, a transparent inner wall panel preferably formed from a glass or a transparent plastic, which wall panels delimit an intermediate space, in particular for conducting gas, and with at least one glove port assigned to the double wall, comprising means for the detachable fixing a glove for reaching through the double wall to manually engage in the isolator space, wherein the glove port comprises a preferably transparent channel ring surrounding a reach-through channel, which channel ring extends from the outer wall panel in the direction of the inner wall panel, wherein the outer wall panel and the inner wall panel are arranged adjustable, in particular swivellable, relative to one another for easier replacement of the glove, and wherein the means for the detachable fixing of the glove in a region between the outer wall panel and the inner wall panel are arranged outside the reach-through channel. The channel ring is preferably constituted either integral with the outer wall panel and thus fixedly connected to the latter or alternatively fixed gas-tight to the outer wall panel, in particular in the region of or inside an outer wall panel opening. The isolator preferably comprises a decontamination device, preferably comprising a vaporisation device, for creating the clean room conditions by means of a decontamination agent, such as for example hydrogen peroxide. Furthermore, the device preferably comprises a fresh air conditioning system.

Furthermore, the invention relates to an isolator system, which comprises, apart from an isolator according to the invention, a glove detachably fixed to the glove port.

Moreover, the invention relates to a method for the detachable fixing of a glove to a glove port of an isolator according to the invention.

Isolators are used for example in the pharmaceutical and chemical industry in order to carry out critical processes, for example sterilisation and/or filling and/or production processes, in an isolator space (clean room) delimited or formed by the isolator. Depending on the application with the isolators, the product is protected against external, atmospheric influences or operatives of an isolator are protected during the processing of hazardous products, in particular products harmful to health. In order that operatives can reach manually into the isolator space from outside, isolators are usually provided with so-called glove ports (glove connections), to which usually elastomer gloves can be fixed detachably, which form a separation barrier between the isolator space and the world outside. Such isolators are also referred to as a glove box or chamber. For good product protection or operative protection, it must be ensured that the glove is fixed securely and gas-tight to the glove port.

Various systems have proved to be effective in practice for the detachable fixing of gloves to the glove port of isolators.

A system is hitherto preferred by the applicant, wherein the glove is fixed to an inner ring arranged tightly inside the channel ring, which inner ring reduces the free cross-section of the channel ring. This system has the advantage that a glove replacement is possible during operation of the isolator, since a new glove provided with an inner ring and introduced for example via a lock during operation of the isolator is introduced from inside into the channel ring by means of a suitable tool and the old glove with the associated inner ring is thus removed to the exterior, wherein the new glove with the inner ring closes the channel in the channel ring. The known system requires an additional fixing step for fixing the glove to an inner ring, for which purpose screw connections of the inner ring can be loosened and the glove can be received in a clamping manner.

Alternative known systems do not provide for replaceability of a glove during operation. A system is known to the applicant from practice, wherein the glove can be fixed to a fixing connection piece extending outwards from the outer wall panel and aligned with the channel ring and can then be pulled inside through the channel ring. Here, however, it is necessary to ensure in a time-consuming way that the glove cannot slip off from the outer fixing connection piece when force is exerted by an operative in the insertion direction during operation. Moreover, the glove, as explained, is guided through the interior of the channel ring, so that a free view through the channel ring, which is transparent in the known embodiment, is restricted considerably by the glove itself. A further problem of the known embodiment consists in the fact that, in the case of a tightness test to be performed regularly, wherein the glove is tested for tightness by inflation and measurement of the pressure loss with the aid of a so-called test disc, which is inserted into the channel ring for this purpose, precisely the critical fixing region of the glove located on the outside of the isolator cannot be tested.

A so-called glove box is known from GB 1 273 926 A, which comprises a complex glove replacement system so that a glove can be replaced during the operation of the glove box. The glove replacement is extremely time-consuming and the construction is complex.

A double-wall handling device is known from DE 694 26 116 T2, wherein the double wall can be reached through by two gloves engaging into one another. An outer of the gloves is fixed in an outer region of the outer wall, whilst an inner glove is fixed to an outer side of the inner wall.

DE 10 2004 030 766 A1 describes a testing system and a method for measuring the tightness of gloves, wherein a glove fixed in a region outside the outer wall is provided for reaching through a double wall.

US 2012/0 023 721 A1 describes a complex system for fixing gloves to a containment.

US 2004/0 168 341 A1 describes a system with a plurality of gloves fixed to an outer region.

US 2008/0 314 744 A1 describes a glove box, wherein a double wall of a glove box is reached through.

### SUMMARY OF THE INVENTION

Proceeding from the aforementioned prior art, therefore, the invention is based on specifying an improved isolator constituted as a glove box, which on the one hand is characterised by a convenient and moreover secure (tight) fixing option for the glove to the glove port and it is nonetheless ensured that the glove can be completely tested for tightness in a regular tightness test. Despite the aforementioned requirements, it should preferably be ensured that the reach-through channel has a large free cross-section, which in particular is not narrowed by an inner ring. Furthermore, the problem consists in specifying an isolator system with an isolator thus improved as well as a method for a convenient and secure glove replacement on such an isolator.

This problem is solved with regard to the isolator with the features disclosed herein.

With regard to the isolator system, the problem is solved with the features disclosed herein.

With regard to the method, the problem is solved with the features disclosed herein.

Advantageous developments of the invention are specified in the sub-claims. All combinations of at least two features disclosed in the description, the claims and/or the figures fall within the scope of the invention. To avoid repetition, features disclosed according to the device are also intended also to be disclosed as being according to the method and can be claimed. Equally, features disclosed according to the method are also deemed to be disclosed as being according to the device and can be claimed.

The idea underlying the invention is to enable an easy and secure fixing of the glove to the glove port, by the fact that the means for the detachable fixing of the glove are arranged in a region between the outer wall panel and the inner wall panel outside the reach-through channel. In other words, provision is made according to the invention such that the glove can be fixed in a region outside the reach-through channel, in particular in the intermediate space, in any event between the outer and inner wall panel, i.e. in a region sealed off by the outer wall panel from the surroundings/atmosphere, through which region gas present inside the isolator space, for example sterile air and/or decontamination agent, for example hydrogen peroxide vapour, flows in a circulation mode and/or during a rinsing operation. The fixing of the glove in this region is accompanied by at least two advantages. On the one hand, the glove can be fixed in a straightforward manner after providing accessibility, in particular after opening of the outer wall panel, without an inner ring required in the prior art and arranged inside the channel ring being required, for example by simply pulling the glove over the channel ring in the direction of the outer wall panel. Moreover, it is advantageous that, with the fixing method according to the invention, the entire glove, in particular also in its fixing region, can be tested for tightness using conventional test devices, in particular test discs, which can be arranged in a sealing manner inside the channel ring in order to inflate the glove and to monitor any pressure loss, since said fixing region is located in a region outside the outer wall panel, unlike solutions known from the prior art. A further advantage consists in the fact that, with the method of fixing according to the invention, an inner ring is not required, which would reduce the free cross-sectional area of the reach-through channel, more precisely of the channel ring, as a result of which the freedom of movement (larger free cross-sectional area) for an operative is substantially improved. Especially when the channel ring is constituted transparent, which is preferable, for example made of glass or a transparent plastic such as polymethyl methacrylate, the operative can see much better at an oblique angle through the channel ring into the isolator space than is possible with prior art solutions, since the direction of vision is not covered or blocked by a glove passed through the channel ring as in the prior art.

In order to increase the safety against undesired detachment of the glove, in particular from the channel ring or some other dummy part, provision is advantageously made according to the invention such that the means for the detachable fixing comprise a securing ring, preferably constituted as an elastomer ring, for example an O-ring, for clamping around the glove and preferably at the same time the channel ring in the region between the outer wall panel and the inner wall panel, wherein this securing ring is pushed, preferably after fixing of the glove, for example in an aforementioned annular groove, or after engagement over an aforementioned annular bead, from the inside over the glove, in particular such that the glove is additionally clamped, in particular directly against the channel ring or the aforementioned other fixing device (in particular a pull-over device).

In order to increase the safety further, provision is also advantageously made according to the invention such that retention means are assigned to the securing ring, that the securing ring is thus arranged relative to the inner wall panel in such a way that the inner wall panel, preferably forming a retaining stop for the securing ring, prevents slipping off of the securing ring from the glove in the direction of the interior (isolator space). To put it another way, the securing ring and the inner wall panel are or can be preferably arranged relative to one another in the operating state in such a way that the securing ring is prevented from slipping off by striking against the inner wall panel. It is particularly preferable for this purpose if the channel ring or another fixing device (in particular a pull-over device) extends at least approximately up to a passage opening in the inner wall panel, very particular preferably into this passage opening or still more preferably some way into the isolator space through this passage opening.

The employed generic term “isolator” is understood in a preferred broad consideration to mean any clean room constellation, in particular apart from conventional isolators, also so-called RABS, which are constituted as so-called glove boxes, in order to be able to reach from outside into a clean room atmosphere inside the clean space (isolator space), and which are provided with a double panel arrangement to delimit the insulator space or clean room, to which a glove port is assigned in order to be able to reach manually from outside through the double panel arrangement (double wall) into the isolator space. It is preferably an isolator for pharmaceutical and/or chemical applications with a decontamination device, in particular comprising an H₂O₂ evaporator.

In principle, it is possible to provide, in addition to the channel ring, a pull-over dummy part, in particular in the region of the intermediate space or between the outer wall panel and the inner wall panel, by means of which pull-over dummy part the glove can be pulled over in particular in the direction of the outer wall panel for its fixing. Particular preference is given, however, to a measure provided in a development of the invention, according to which the channel ring is designed to directly receive an engagement-side (i.e. rear-side) end of the glove (fixing end) by being pulled over the latter.

Overall, it is advantageous if the means for the detachable fixing of the glove are arranged on the outer circumference of the channel ring and still more preferably are formed at least partially by the outer circumference of the channel ring itself. The means are preferably arranged offset at a distance from the outer wall panel in the direction of the inner wall panel in order to maximise the free viewing area through the channel ring (with a preferred, but not imperative transparent embodiment). In order to design the glove replacement in a particularly convenient manner, provision is advantageously made within the scope of the invention such that the outer wall panel and the inner wall panel are adjustable, in particular swivellable, relative to one another, in order that the glove can be fixed, after the spacing of the wall panels apart from one another, to the means for the detachable fixing of the glove, in particular directly to the channel ring. The outer wall panel and the inner wall panel are preferably arranged parallel to one another during the operating status of the isolator. Irrespective of whether the outer wall panel and the inner wall panel are adjustable, in particular swivellable, relative to one another, it is preferable if the inner wall panel and the outer wall panel, preferably jointly, are components of an adjustable, in particular swivellable door, through which it is possible to reach into the isolator space (with the opened door) when not in operation.

It has proved to be particularly advantageous if an annular groove, in particular open outwards in the direction of the intermediate space, for the, in particular, clamping accommodation of an, in particular, engagement end-side glove bead ring is arranged on a side of the outer wall panel facing the isolator space, in particular directly in the outer circumference of the channel ring or alternatively in a fixing device fixed for example to the channel ring and provided in addition to the channel ring. In addition or as an alternative to the provision of an annular groove, an annular bead which can be pulled over by means of the glove bead ring, in particular in the direction of the outer wall panel, can be provided, for example directly at the outer circumference of the channel ring or of a device additionally provided, wherein the annular groove and the annular bead are intended to ensure good clamping capacity and a secure fit of the glove. In addition or as an alternative to an annular groove or an annular bead, the means for the detachable fixing can comprise other or additional fixing options, for example a fixing device, in particular in the region between the inner and the outer wall panel.

In order to ensure a good fit of the securing ring, in particular at the outer circumference of the channel ring or the retaining dummy part (in each case above or outside the glove), provision is advantageously made in a development of the invention such that a retaining groove, in particular open in the direction of the intermediate space, is assigned to the securing ring, in particular in the outer circumference of the channel ring or an optional additional retaining dummy part, wherein the glove runs through or engages over the retaining groove when the glove is fixed. In addition or as an alternative to a retaining groove (annular groove), a retaining bead can be provided, which prevents slipping-off or a movement of the securing ring in the direction of the inner wall panel. For the preferred case of the provision of an annular groove and/or an annular bead for the glove bead, it is preferable if the retaining groove and/or the retaining bead for the securing ring is located in a region between the annular groove or annular bead and the inner wall panel, in particular in the outer circumference of the channel ring or the additional fixing device.

As already indicated, an opening (passage opening) is preferably located in the inner wall panel, which opening is aligned with the reach-through channel surrounded by the channel ring, in order to be able to reach through by means of the glove. The channel ring preferably extends at least approximately from the outer wall panel up to this opening, still more preferably into the opening and very particularly preferably beyond the opening into the isolator space. It is preferable if any remaining annular gap between the, for example, circular or oval-contoured channel ring elongated in the engagement direction is dimensioned such that an aforementioned, optional securing ring can strike in the edge region of the opening in the inner wall panel or can be retained by such an edge region.

Provision is made within the scope of the method according to the invention such that the glove, in particular made of an elastomer material and/or comprising five fingers and/or an end-side glove annular bead is fixed, in particular with an engagement-side end, preferably comprising the aforementioned glove annular bead, outside the reach-through channel in the region between the outer and the inner wall panel, in particular in the intermediate region, to the glove port, preferably directly at the outer circumference of the channel ring. It is particularly expedient if, for this purpose, the outer and the inner wall panel are moved away from one another, in particular swivelled away, in order to be able to pull the glove over in the direction of the inside of the outer wall panel, for example directly onto the channel ring then comprising a free end or an additionally provided dummy part, in particular with the glove annular bead into an annular groove or over an annular bead. Provision is made according to the invention such that the glove is additionally secured by a securing ring, which is placed, in particular clamped, around the glove, in particular into a corresponding retaining groove or behind a corresponding retaining bead, preferably also from the direction of a free end of the channel ring, wherein an original relative position of the wall panels relative to one another, in particular in parallel, is adjusted after the fixing has taken place and after a preferred passing of the glove through a passage opening of the inner wall. The inner wall panel secures the securing ring against slipping off in this relative position.

### BRIEF DESCRIPTION OF THE DRAWINGS

Further advantages, features and details of the invention emerge from the following description of preferred examples of embodiment and with the aid of the drawings.

In the figures:

FIG. 1: shows a detail of an isolator with a double wall constituted as a glove box, comprising an outer wall panel constituted as a double-glass panel and a single inner wall panel offset in parallel with respect to the latter in the direction of the isolator space, in an oblique perspective view, wherein a glove port with a glove only partially represented is assigned the double wall,

FIG. 2: shows a plan view of the glove port arrangement from inside from the direction of the isolator space,

FIG. 3: shows a cross-sectional representation along intersecting line A-A according to FIG. 2, and

FIG. 4: shows an enlarged detail Z from FIG. 3.

### DETAILED DESCRIPTION

Identical elements and elements with the same function are denoted by the same reference symbols in the figures.

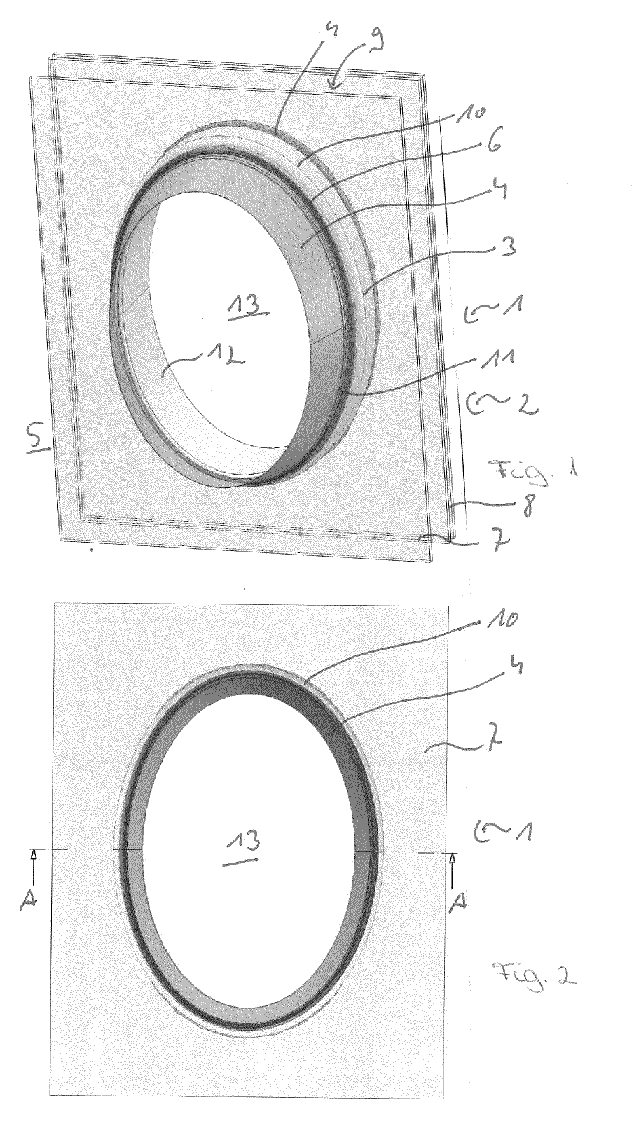

A detail of an isolator 1, for example for pharmaceutical applications, is shown in FIG. 1. The latter comprises a double wall 2, to which a glove port 3 is assigned, to which a flexible glove 4 represented only partially, for reaching into an isolator space 5 delimited by double wall 2, is already fixed here with an engagement-side end 6, and more precisely in a region between a transparent inner wall panel 7 constituted as a single glass panel and an outer wall panel 8 constituted as a double-glass panel of double wall 2. Inner wall panel 7 and outer wall panel 8 delimit an intermediate space 9, which serves as a flow channel for conveying gas and/or disinfection agent in a circulation mode, wherein gas is usually fed back with a fan through the intermediate space from the bottom to the top in a circulation generator space and is then conveyed through a flow calming section (laminar flow section) from the top into the isolator space.

Glove port 3 comprises, for example, an oval-contoured channel ring 10 made from a transparent, colourless plastic material, which extends from outer wall panel 8 in the direction of inner wall panel 7 and, as will be explained in further detail below, some way through the latter or an opening 11 provided therein into isolator space 5. Oval-contoured channel ring 10 directly delimits with inner circumference 12 a reach-through channel 13, through which an operative can reach from outside into glove 4 and can thus reach into double wall 2 without risk to products or operatives. Channel ring 10 is fixed tightly in the region of an opening edge of an opening 14, which is aligned with opening 11 at outer wall panel 8.

FIG. 2 shows a vertical plan view onto the arrangement according to FIG. 1 from inside—that is to say that glove 4 projects out of the plane of the drawing.

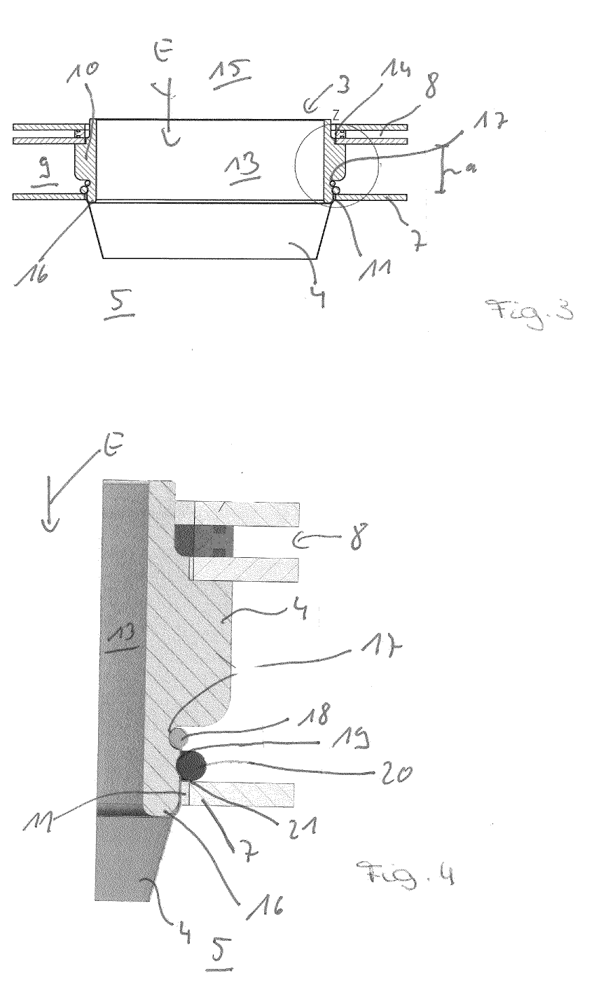

In the following, a preferred detail structure of the isolator constituted according to the concept of the invention according to FIGS. 1 and 2 will be explained with the aid of FIGS. 3 and 4.

Glove port 3 is shown in detail in FIG. 3. The latter comprises transparent channel ring 10, made for example of polymethyl methacrylate and fixed to outer wall panel 8, which channel ring, in the example of embodiment shown, covers a distance a of, for example, 8 cm between outer wall panel 8 and inner wall panel 7. Channel ring 10 is tightly fixed inside opening 14 at outer wall panel 8 constituted as a double panel, so that no gas can pass from intermediate space 9 formed between wall panels 7, 8 into a surrounding area 15 outside outer wall panel 8, i.e. on the side facing away from isolator space 5. Channel ring 10 penetrates with its free end 16 through opening 11 some way into isolator space 5.

It can be seen that an annular groove 17 spaced apart from outer wall panel 8 in the direction of inner wall panel 7 is provided at the outer circumference of channel ring 10, inside which annular groove an end-side glove bead 18 is accommodated in a clamping manner. For this purpose, glove 4 is pulled from inside in the direction of outer wall panel 8 over free end 16 of channel ring 10.

A further retaining groove 19 constituted as an annular groove is located between annular groove 17 and inner wall panel 7, in which further retaining groove a securing ring 20 constituted as an elastomer O-ring is accommodated in a clamping manner. This retaining groove 19 is penetrated by a circumferential portion of glove 4 axially along an engagement direction E for an operative, so that this portion of glove 4 is pressed or clamped by securing ring 20 against the outer circumference of channel ring 10, more precisely against the groove base of retaining groove 19. Securing ring 20 is thus located axially along engagement direction E between rear bead-shaped end or glove annular bead 18 of glove 4 and an opening edge 21 of opening 11 (passage opening) of inner wall panel 7, which thus forms a stop for securing ring 20 and prevents the latter from slipping off in the direction of isolator space 5.

Inner wall panel 7 is swivellable relative to outer wall panel 8 (not represented), so that channel ring 10 or its free end fixed to outer wall panel 8 can swivel backwards out of inner wall panel 7 or opening 11, in order thus to be able to remove securing ring 20 and to pull off glove 4 and then to pull on a new glove 4 and to secure it again with securing ring 20. In addition to the relatively swivellable arrangement of wall panels 7, 8 with respect to one another, wall panels 7, 8 are arranged so as to be swivellable jointly relative to a further (not shown) wall section (housing section) of isolator space 5, in order thus to facilitate the possibility of access when glove 4 is being replaced and at the same time to be able to reach into isolator space 5 via a larger opening when not in operation.

### REFERENCE NUMBERS

1 isolator
2 double wall
3 glove port
4 glove
5 isolator space
6 engagement-side end
7 inner wall panel
8 outer wall panel
9 intermediate space
10 channel ring
11 opening in the inner wall panel
12 inner circumference
13 reach-through channel
14 opening in the outer wall panel
15 (external) environment
16 free end
17 annular groove
18 glove annular bead
19 retaining groove
20 securing ring
21 opening edge
a spacing (generally preferably between 5 cm and 15 cm)
A-A intersecting line
E engagement direction
Z detail

1. An isolator (1) for pharmaceutical and/or chemical applications, with an isolator space (5) having a double wall (2), wherein the double wall (2) comprises at least one transparent outer wall panel (8) and a transparent inner wall panel (7) spaced apart from the latter, which wall panels delimit an intermediate space (9) for conducting gas, and with at least one glove port (3) assigned to the double wall (2), comprising means for the detachable fixing a glove (4) for reaching through the double wall (2) to manually engage in the isolator space (5), wherein the glove port (4) comprises a channel ring (10) surrounding a reach-through channel (13), which channel ring extends from the outer wall panel (8) in the direction of the inner wall panel (7), wherein the means for the detachable fixing of the glove (4) in a region between the outer wall panel (8) and the inner wall panel (7) are arranged outside the reach-through channel (13), wherein the outer wall panel (8) and the inner wall panel (7) are arranged displaceable relative to one another for facilitated glove replacement,
wherein
the means for the detachable fixing comprise a securing ring (20), and wherein the securing ring (20) is arranged relative to the inner wall panel (7) in such a way that the inner wall panel (7), prevents slipping off of the securing ring (20) from the glove (4) in the direction of the interior space.

2. The isolator according to claim 1, wherein the means for the detachable fixing of the glove (4) are arranged at the outer circumference of the channel ring (10).

3. The isolator according to claim 1, wherein the means for the detachable fixing of the glove (4), at the outer circumference of the channel ring (10), comprise an annular groove open outwards in the direction of the intermediate space, for the accommodation of an engagement end-side glove annular bead (18), and/or an annular bead over which an engagement end-side glove annular bead (18) and/or a clamping device engages.

4. The isolator according to claim 1, wherein a retaining groove (19), open in the direction of the intermediate space (9), for the securing ring (20) and/or a retaining bead are assigned to the securing ring (20), wherein the retaining groove (19) and/or the retaining ring is/are arranged, in an engagement direction (E) through the glove port (3), behind the annular groove (17) and/or the annular bead for the glove annular bead (18), before the inner wall panel (7).

5. The isolator according to claim 1, wherein an opening (11) aligned with the reach-through channel (13) is arranged in the inner wall panel (7), wherein the channel ring (10) extends at least up to this opening (11), into the opening (11) or through the opening (11) into the isolator space (5).

6. The isolator according to claim 1, wherein no further channel ring (10) of the glove port (3) is arranged inside and/or outside the channel ring (10).

7. The isolator according to claim 1, wherein the double wall (2) carrying the glove port (3) is a component of an adjustable door.

8. An isolator system comprising an isolator (1) according to claim 1, wherein a glove (4) is assigned to the glove port (3), which glove is fixed detachably to the means for the detachable fixing of the glove (4) outside the reach-through channel (13) in a region between the outer wall panel (8) and the inner wall panel (7), by means of an open engagement end, wherein the glove (4), in a region between the outer wall panel (8) and the inner wall panel (7), is engaged in a clamping manner, by an elastomer securing ring (20) which is accommodated in a retaining groove (19) and/or which engages around a retaining bead, which securing ring is secured against slipping off by means of the inner wall panel (7).

9. The isolator system according to claim 8, wherein the glove (4) is accommodated in a clamping manner, with an engagement end-side glove annular bead (18) in an annular groove (17), at the outer circumference of the channel ring (10) and/or engages with an engagement end-side glove annular bead (18) over an annular bead (17) at the outer circumference of the channel ring (10).

10. A method for the detachable fixing of a glove (4) to a glove port (3) of an isolator (1) according to claim 1, wherein the glove (4), with an engagement-side end (6), is fixed outside the reach-through channel (13) in a region between the outer (8) and the inner wall panel (7) to the glove port (3) at the outer circumference of the channel ring (10),
wherein
a preferably elastomer securing ring (20) is placed, in a clamping manner, around the glove (4) in the region between the outer (8) and the inner wall panel (7), and the outer wall panel (8) and the inner wall panel (7) are then moved towards one another to secure the securing ring (20) against slipping off.

11. The isolator according to claim 1, wherein the channel ring (10) is transparent.

12. The isolator according to claim 1, wherein the outer wall panel (8) and the inner wall panel (7) are arranged swivellable relative to one another.

13. The isolator according to claim 1, wherein the securing ring (20) is constituted as an elastomer ring, for clamping around the glove (4) and the channel ring (10) in the region between the outer wall panel (8) and the inner wall panel (7).

14. The isolator according to claim 1, wherein the inner wall panel (7) forms a retaining stop.

15. The isolator according to claim 2, wherein the means for the detachable fixing are arranged off set in the direction of the inner wall panel (7) spaced apart from the outer wall panel (8).

16. The isolator according to claim 7, wherein the adjustable door is a swivellable door.

17. The method according to claim 10, wherein the outer wall panel (8) and the inner wall panel (7) are swivelled towards one another to secure the securing ring (20) against slipping off.
